(19) United States
(12) Patent Application Publication
(10) Pub. No.: US 2005/0205487 A1
(43) Pub. Date: Sep. 22, 2005

(54) Combination colander bowl and container set

(76) Inventor: Roger D. Rogers, Memphis, TN (US)

Correspondence Address: Richard C. Litman;LITMAN LAW OFFICES, LTD., P.O. Box 15035, Arlington, VA, 22215, US

(21) Appl. No.: 10/803,053

(22) Filed: Mar. 18, 2004

(51) Int. Cl. B01D 35/02

(52) U.S. Cl. 210/464; 210/473; 99/290

(57) ABSTRACT

The combination colander bowl and container set includes a colander bowl (a bowl with an integrated strainer and removable bottom plate that can be used as a colander when the bottom plate is removed), a cover that forms an air-tight seal with the bowl, and four snap-on lids that allow the cover, bowl and bottom plate to be used for food storage. The bowl is used to season food by placing the food and seasoning in the bowl, attaching the cover and then shaking, or as a colander by removing the bottom plate from the bowl. The components of the device can be used separately as three storage containers. In an alternative embodiment, the set includes a tripod and a crank handle for rotating the colander bowl on the tripod.

### BACKGROUND OF THE INVENTION

1. Field of the Invention

The present invention relates to food preparation and storage, and more particularly, to an apparatus for seasoning and straining food that includes a bowl with an integrated strainer and removable bottom plate, a cover that forms an air-tight seal with the bowl, and four snap-on lids that allow the cover, bowl and bottom plate to be used for food storage.

2. Description of the Related Art

A colander is a bowl-shaped kitchen utensil with perforations for draining off liquids or rinsing food. Although colanders are not typically furnished with a cover, it can be used to season food by placing food and seasoning inside the bowl and then shaking gently to avoid spilling the contents. However, using a colander to season food in this manner has several drawbacks. First, the unused seasoning is not easily retrieved, but is typically spilled and wasted. Second, the colander cannot be inverted to better facilitate spreading the seasoning on the food. And third, the colander cannot be used effectively as a storage container for the seasoned food or any unused seasoning.

Examples of ornamental designs for colanders and similar devices subject to the aforementioned drawbacks are provided by U.S. Design Pat. No. 185,399, issued on Jun. 2, 1959 to E. S. Tupper (combined strainer and container cover); U.S. Design Pat. No. 251,050, issued on Feb. 13, 1979 to H. I. Wallsten (combined sieve and holder); U.S. Design Pat. No. 296,969, issued on Aug. 2, 1988 to A. R. Carlson (strainer); U.S. Design Pat. No. 327,609, issued on Jul. 7, 1992 to A. R. Carlson (combined bowl and strainer); U.S. Design Pat. No. 332,204, issued on Jan. 5, 1993 to A. R. Carlson (combined container and convertible grid); U.S. Design Pat. No. 353,080, issued on Dec. 6, 1994 to V. J. Cantereels et al. (colander work unit); U.S. Design Pat. No. 353,303, issued on Dec. 13, 1994 to J. E. Davis (combined cooking utensil); U.S. Design Pat. No. 424,381, issued on May 9, 2000 to D. M. Terenzio (bowl and colander set); U.S. Design Pat. No. 425,378, issued on May 23, 2000 to M. A. Gilbertson (combined colander and bowl set); and U.S. Design Pat. No. 468,168, issued on Jan. 7, 2003 to M. W. Gruenberg, Sr. (combination colander and container for popcorn kernels).

Other colanders and strainers are described in U.S. Pat. No. 1,662,343, issued on Mar. 12, 1927 to N. E. Sharpneck et al. (safety drainer); U.S. Pat. No. 5,368,170, issued on Nov. 29, 1994 to A. C. Leis (popcorn colander); U.S. Pat. No. 5,957,038, issued on Sep. 28, 1999 to J. J. Shimazaki (cooking pot with strainer); and U.S. Pat. No. 6,126,018, issued on Oct. 3, 2000 to J. W. Cone et al. (grease straining and collecting device).

None of the above inventions and patents, taken either singly or in combination, is seen to describe the instant invention as claimed. Thus, a combination colander bowl and container set solving the aforementioned problems is desired.

### SUMMARY OF THE INVENTION

The combination colander bowl and container set includes a colander bowl (a bowl with an integrated strainer and removable bottom plate that can be used as a colander when the bottom plate is removed), a cover that forms an air-tight seal with the bowl, and four snap-on lids that allow the cover, bowl and bottom plate to be used for food storage. The device is used to season food by placing the food and seasoning in the bowl, attaching the cover and then shaking. The bowl can be inverted to better facilitate spreading the seasoning onto the food. The unused seasoning is not spilled and wasted, but remains in the bowl where it is easily retrieved or stored. Further, the components of the device can be used separately as three discrete storage containers.

In an alternative embodiment, the set includes a tripod and a crank handle for rotating the colander bowl on the tripod.

Accordingly, it is a principal object of the invention to provide a colander bowl that can be used to season food.

It is another object of the invention to provide a colander bowl that minimizes the spilling and waste of seasoning when seasoning food.

It is a further object of the invention to provide a colander bowl with components that can be used as separate storage containers.

Still another object of the invention is to provide a colander bowl that is configured for use in commercial environments, such as restaurants.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a partially exploded, environmental, perspective view of a combination colander bowl and container set according to the present invention.

FIG. 2 is a perspective view of a combination colander bowl and container set according to the present invention.

FIG. 3 is an exploded view the combination colander bowl and container set of FIG. 2.

FIG. 4 is an exploded view of the cover and mating lid for a combination colander bowl and container set according to the present invention.

FIG. 5 is an exploded view of the bowl and mating lids for a combination colander bowl and container set according to the present invention.

FIG. 6 is an exploded view of the bottom plate and mating lid for a combination colander bowl and container set according to the present invention.

FIG. 7 is a side elevational view of a combination colander bowl and container set according to the present invention with the strainer shown in hatched lines.

FIG. 8 is a perspective view of an alternative embodiment of a combination colander bowl and container set according to the present invention.

FIG. 9 is an exploded view of the combination colander bowl and container set of FIG. 8.

Similar reference characters denote corresponding features consistently throughout the attached drawings.

### DETAILED DESCRIPTION OF THE PREFERRED EMBODIMENTS

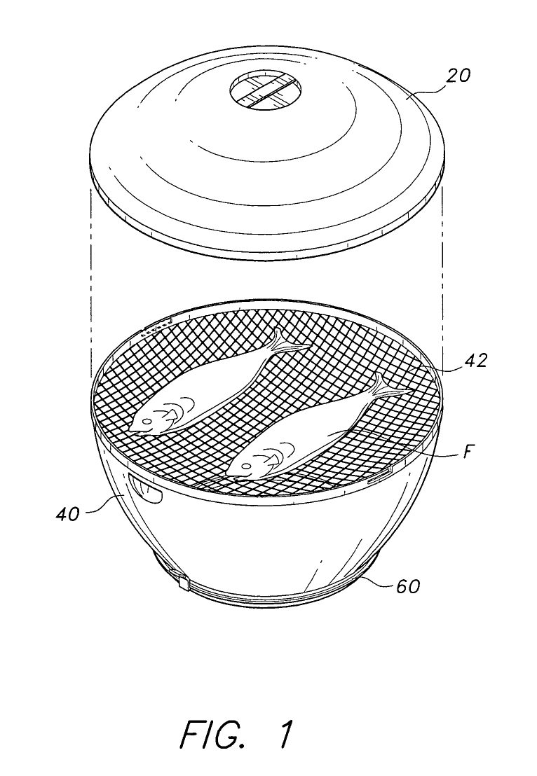

The present invention is a combination colander bowl and container set. FIG. 1 shows the colander bowl 40 with cover 20 and attached bottom plate 60 as it may be configured to season food, e.g., fish F.

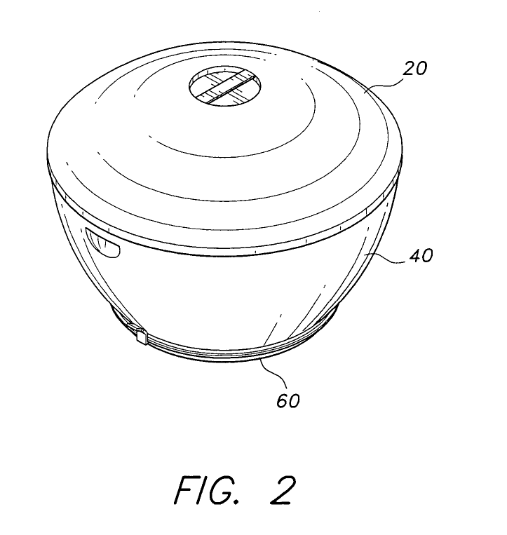

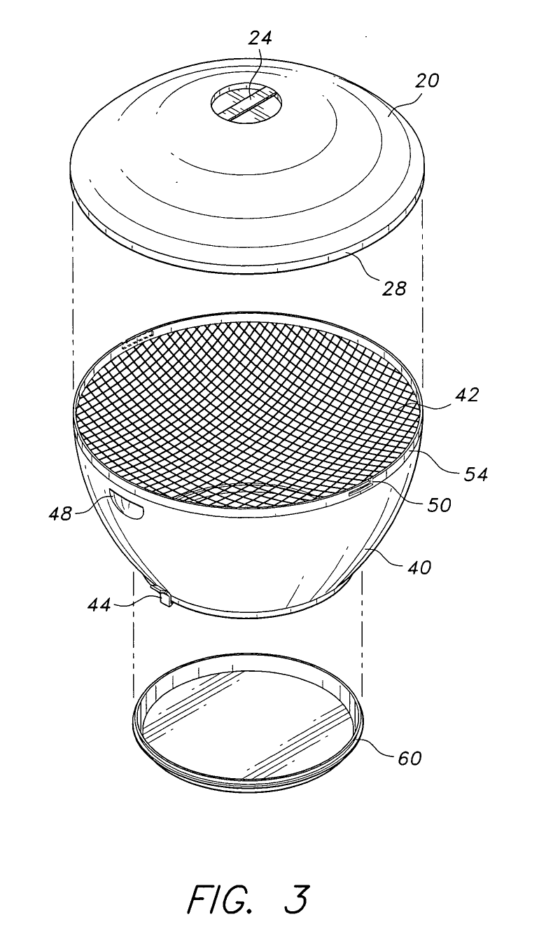

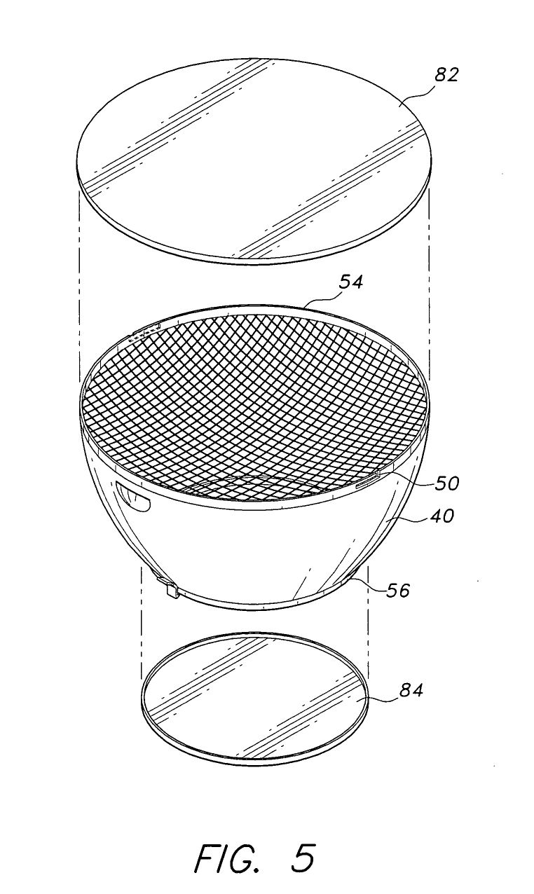

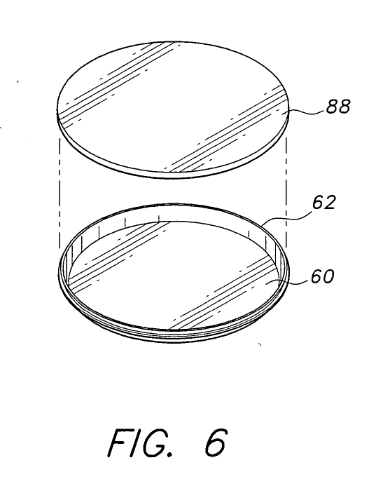

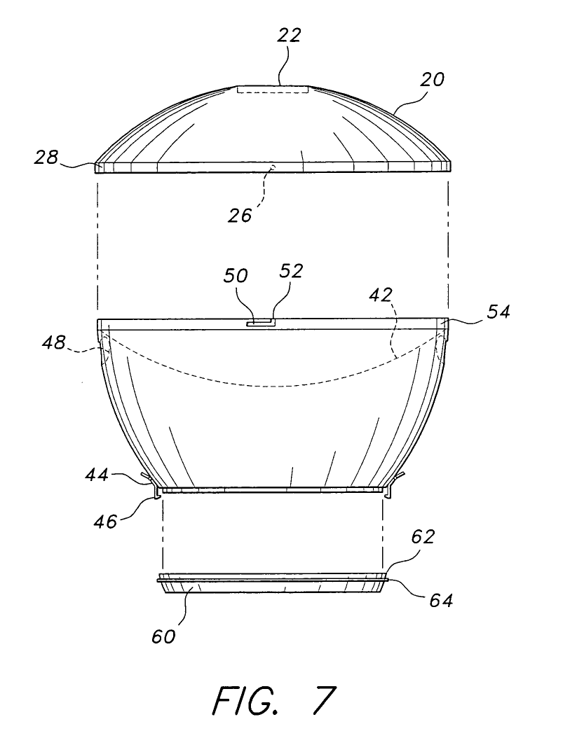

Referring to FIGS. 1-7, the bowl 40 includes an integrated strainer 42 that is concave downward with an outer rim permanently attached to the inner surface of the bowl 40. The bowl 40 is formed with an open bottom that is covered by the removable bottom plate 60. The bottom plate 60 is secured to the bottom of the bowl 40 by two rigid clips 44 that are attached to the outer surface of the bowl 40. Each clip 44 is formed with an arcuate profile and a hook 46 at its bottom, as shown in FIG. 7. When the top portion of a clip 44 is pressed, hook 46 moves outwardly, thereby releasing a lip 64 that encircles the outer aspect of the rim 62 of the bottom plate 60. Two handle cavities 48 are formed in opposite sides of the outer wall of the bowl 40.

The cover 20 is convex upwardly with a substantially flat portion 22 in the center of its topside that supports the cover 20 when placed on a flat surface in an inverted position. In such an orientation, the cover 20 can be used as a bowl. A handle 24 is formed in a recess defined in the flat portion 22.

Two horizontal pins 26 extend inward from the inner aspect of the rim 28 of the cover 20. The horizontal pins 26 mate with two horizontal slots 50 on the rim 54 of the bowl 40 to allow for twist engagement of the cover 20 and the bowl 40. Each of the horizontal slots 50 has a vertical opening 52 that allows a corresponding pin 26 to be inserted into the slot 50.

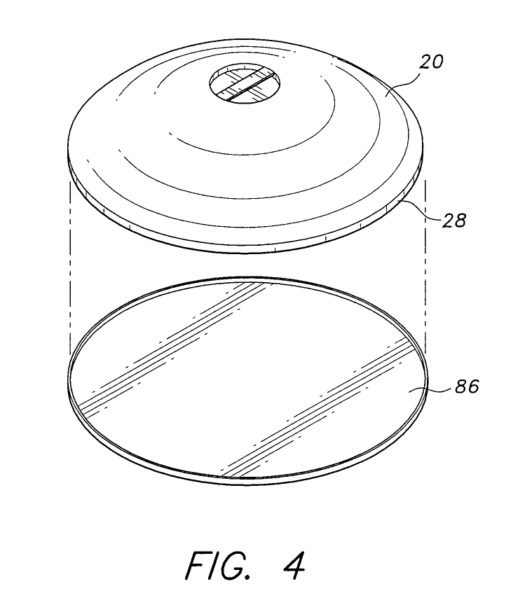

As shown in FIGS. 4, 5 and 6, the set includes four snap-fit lids 82, 84, 86 and 88. A first lid 82 is shaped and dimensioned for snap-fit engagement around the upper rim 54 of the bowl 40, and a second lid 84 is shaped and dimensioned for snap-fit engagement around the rim 56 of the bottom opening in the bowl 40. A third lid 86 is shaped and dimensioned for snap-fit engagement around the rim 28 of the cover 20 and a fourth lid 88 is shaped and dimensioned for snap-fit engagement around the rim 62 of the bottom plate 60. Thus, each of the cover 20, bowl 40 and bottom plate 60 can function as a separate substantially airtight container.

The cover 20, bowl 40, bottom plate 60 and four lids 82, 84, 86 and 88 are constructed of plastic.

In a slightly modified embodiment (not shown), the cover 20 also includes two recessed handles on opposite sides of its topside. These handles would align with the recessed handles in the bowl when the bowl and cover are engaged. In another slightly modified embodiment, the bottom plate 60 is secured to the bottom of the bowl 40 using the same pin 26 and slot 50 engagement used to secure the cover 20 to the bowl 40 discussed above.

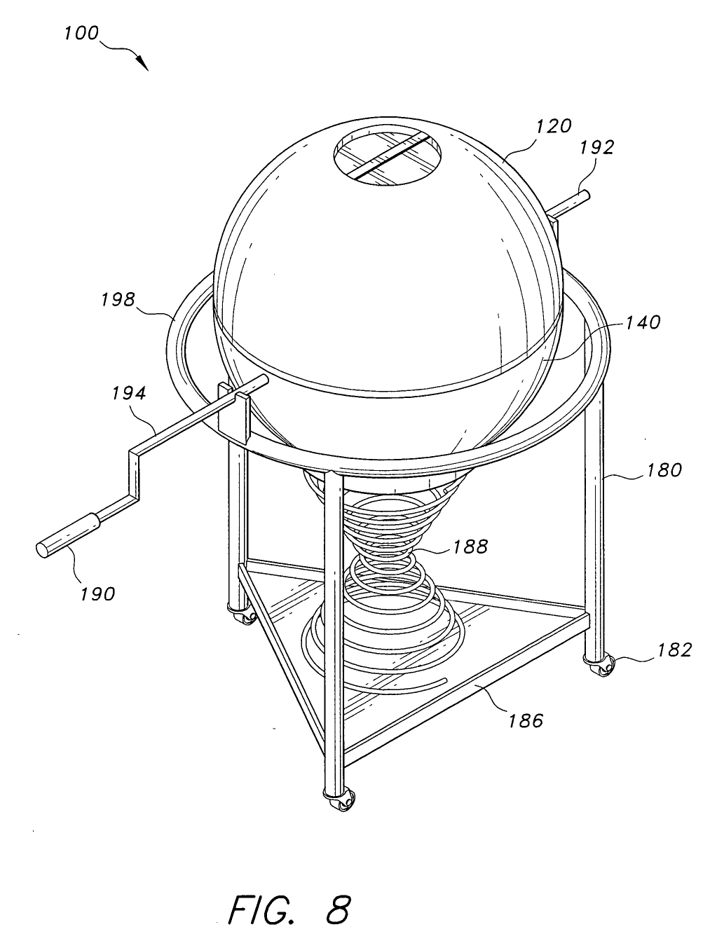

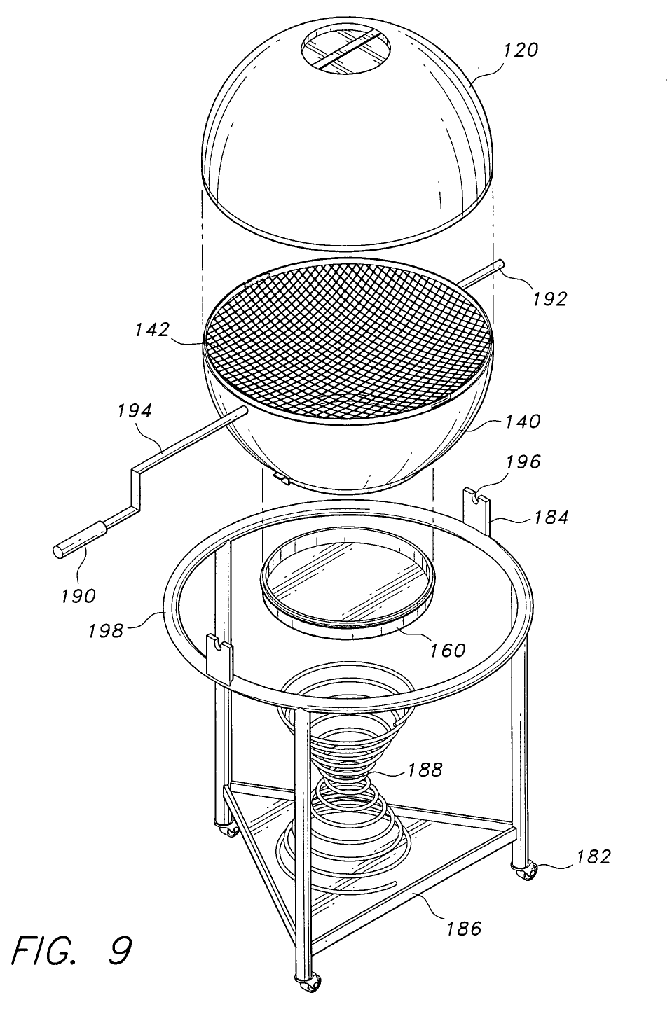

In another embodiment, shown in FIGS. 8 and 9, the combination colander bowl and container set has a 140 is supported by a tripod 180. The tripod 180 has an upper rim 198 from which three legs depend, and a triangular base 186 with each of its three corners attached to a separate leg. Each leg is mounted on a wheel 182. A crank handle 190 with a horizontal main shaft 194 extends from the outer wall of the bowl 140 and a horizontal rod 192 extends from an opposite point on the outer wall of the bowl 140. The main shaft 194 and horizontal rod 192 are coaxial and are supported by two flanges 184 that extend upwardly from the rim 198. The upper edge of each flange 184 has a semi-circular notch 196 in which the main shaft 194 and horizontal rod 192 rest and can spin freely to rotate the bowl 140.

As with the first embodiment, the cover 120 is secured to the bowl 140 via pin and slot engagement. The bowl 140 is equipped with a strainer 142 permanently attached to its inner surface and has an open bottom that is covered by a removable bottom plate 160. A spring 188 is provided to support the bottom plate 160 when it is released from the bottom of the bowl 140. The spring 188 is mounted on the triangular base 186.

This embodiment can be constructed of metal, plastic or a combination thereof.

It is to be understood that the present invention is not limited to the embodiments described above, but encompasses any and all embodiments within the scope of the following claims.

1. A combination colander bowl and container set, comprising:
a bowl having an inner surface, an outer surface, and an upper rim defining a top opening;
a cover shaped and dimensioned to cover the top opening of the bowl, the cover having a rim; and
a strainer having an outer rim attached to the inner surface of the bowl.

2. The combination colander bowl and container set according to claim 1, wherein said bowl has an open bottom and a lower rim extending around the open bottom, the set further comprising a removable bottom plate covering the open bottom of said bowl, the bottom plate having a rim, whereby the bottom plate is removable from said bowl in order to use said bowl as a colander.

3. The combination colander bowl and container set according to claim 2, further comprising:
a first lid attachable to said cover, the first lid forming a snap-fit to the rim of said cover, whereby the first lid and said cover form a first substantially airtight container when the first lid is attached to said cover;
a second lid attachable to the rim defining the top opening of said bowl, the second lid forming a snap-fit to the upper rim covering the top opening;
a third lid attachable to the lower rim of said bowl, the third lid forming a snap-fit to the lower rim covering the open bottom of said bowl, whereby the second lid, the third lid, and said bowl form a second substantially air-tight container when the second and third lids are attached to said bowl;
a fourth lid attachable to said bottom plate, the fourth lid forming a snap-fit to the rim of said bottom plate, whereby the fourth lid and said bottom plate form a third substantially air-tight container when the fourth lid is attached to said bottom plate.

4. The combination colander bowl and container set according to claim 1, wherein said cover is convex upwardly, having a top side, a bottom side and a substantially flat center portion in the top side, whereby the flat center portion rests substantially flush against a flat surface when said cover is inverted and placed on the flat surface.

5. The combination colander bowl and container set according to claim 4, further comprising a handle formed in the top side of said cover.

6. The combination colander bowl and container set according to claim 5, further comprising a pair of handles disposed on the outer surface of said bowl.

7. The combination colander bowl and container set according to claim 1, wherein said cover and said bowl are made from plastic.

8. A combination colander bowl and container set, comprising:
a bowl having an inner surface, an outer surface, a horizontal rod extending from outer surface, and a crank handle with a main shaft extending horizontally from a point on the outer surface opposite the horizontal rod, the main shaft and the horizontal rod being coaxial;
a cover attachable to said bowl;
a strainer having an outer rim attached to the inner surface of said bowl; and
a tripod, the bowl being rotatably supported on the tripod by the horizontal rod and the main shaft, and the bowl being rotatable about the coaxial horizontal rod and main shaft by turning the crank handle.

9. The combination colander bowl and container set according to claim 8, wherein said bowl has an open bottom, the set further comprising a removable bottom plate covering the open bottom of said bowl.

10. The combination colander bowl and container set according to claim 9, further comprising a spring disposed on said tripod, said spring being positioned below said bottom plate, whereby said bottom plate is supported on the spring when said bottom plate is removed from said bowl.

11. The combination colander bowl and container set according to claim 8, further comprising a plurality of wheels attached to said tripod, said tripod being supported on said plurality of wheels.
